(19) United States
(12) Patent Application Publication
(10) Pub. No.: US 2010/0120481 A1
(43) Pub. Date: May 13, 2010

(54) Switching circuit

(75) Inventor: Toshio Suda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/588,885

(22) Filed: Oct. 30, 2009

(30) Foreign Application Priority Data
Nov. 7, 2008 (JP) 2008-286305

(51) Int. Cl. H04M 1/00

(52) U.S. Cl. 455/575.7

(57) ABSTRACT

A switching circuit that includes a first transfer path and a second transfer path that transfer a high frequency signal, a first transistor that electrically cuts off a common node between the first transfer path and the second transfer path and the first transfer path if the high frequency signal is transferred via the second transfer path, a second transistor that electrically cuts off the common node and the second transfer path if the high frequency signal is transferred via the first transfer path, a first control voltage input terminal that inputs a high-level control voltage if the high frequency signal is transferred via one of the first transfer path and the second transfer path, and a first voltage supply path that supplies a voltage according to the high-level control voltage to the common node.

### BACKGROUND

1. Field of the Invention

The present invention relates to a switching circuit.

2. Description of Related Art

In a communication device such as a cellular phone, one antenna is shared by multiple transmit circuits and receive circuits. In the communication device having such configuration, a switching circuit is provided for switching antenna transmission and reception. The switching circuit cuts off between the other circuits and the antenna while one transmit or receive circuit is using the antenna. In recent years, the switching circuit is required to improve distortion characteristics, such as high harmonic and intermodulation distortion.

FIG. 8 illustrates the configuration of a typical switching circuit for switching antenna transmission and reception (the switching circuit hereinafter referred to as an ANT switching circuit) according to a related art. The ANT switching circuit 1 has SPnT (Single pole, n throw) configuration (n=3). As illustrated in FIG. 8, the ANT switching circuit 1 includes an antenna connection terminal ANT, FETs (Field Effect Transistor) Tr1 to Tr4, resistance elements R1 to R4, RF terminals RF1 to RF3, and DC control voltage input terminals DC1 to DC4. Suppose that all of the resistances of resistance elements R1 to R4 are the same value Ra. In this case, a DC potential of the antenna connection terminal ANT is determined by the resistance Ra and opposite direction gate current values of FETTr to Tr4.

In order for the ANT switching circuit 1 to achieve sufficiently low distortion characteristics, it is necessary to increase the resistance Ra of the resistance elements R1 to R4 connected in series to each gate of the FETTr1 to Tr4 respectively, so that the gates have high impedance. However, if the resistance Ra is increased, the DC potential of the antenna connection terminal ANT is reduced by the voltage drop and the voltage between gate and source of FET in the OFF state is also reduced. Therefore, sufficient opposite direction voltage is not applied to FETTr1 to Tr4 in the OFF state. If a high power signal is input to the ANT switching circuit 1 in this state, FETTr1 to Tr4 cannot maintain the OFF state and output characteristics required for the transmit path cannot be obtained.

To solve this problem, there is an ANT switching circuit 2 for switching transmission and reception of an antenna circuit with the configuration illustrated in FIG. 9. As illustrated in FIG. 9, in addition to the configuration of the ANT switching circuit 1, the ANT switching circuit 2 further includes a diode D1, a resistance element R5, and a control voltage input terminal DC5. Suppose that the resistance of the resistance element R5 is Rb. If the relationship between the resistances Ra and Rb is Ra>Rb, the voltage supplied to the antenna connection terminal ANT can be increased, and a sufficient bias voltage can be supplied to FET in OFF state. Note that the circuit having the configuration to supply a bias voltage to FET in OFF state is disclosed in Japanese Unexamined Patent Application Publication No. 2006-135666, as with the ANT switching circuit 2.

### SUMMARY

However, the present inventor has found a problem that the circuit disclosed in Japanese Unexamined Patent Application Publication No. 2006-135666 and the ANT switching circuit 2 require a terminal dedicated for supplying a bias voltage (DC5 in FIG. 9). Therefore, an external terminal must be added to an IC which forms the ANT switching circuit 2 or a module which includes the IC. This causes the problem of increasing the package and module volume.

An exemplary aspect of an embodiment of the present invention is a switching circuit that includes a first transfer path and a second transfer path that transfer a high frequency signal, a first transistor that electrically cuts off a common node between the first transfer path and the second transfer path and the first transfer path if the high frequency signal is transferred via the second transfer path, a second transistor that electrically cuts off the common node and the second transfer path if the high frequency signal is transferred via the first transfer path, a first control voltage input terminal that inputs a high-level control voltage if the high frequency signal is transferred via one of the first transfer path and the second transfer path, and a first voltage supply path that supplies a voltage according to the high-level control voltage to the common node.

The switching circuit according to the present invention enables to apply a voltage according to a high-level control voltage which is input to the first control voltage input terminal to a common node as a bias voltage. This enables to maintain the OFF state of a transistor in a transfer path not used by the bias voltage without increasing the terminals even if a high frequency signal is transferred in the first or the second transfer path that transfers a high frequency signal.

The switching circuit according to the present invention achieves a stable operation of the switching circuit and also prevents from increasing the number of terminals.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is an example of an ANT switching circuit according to a first exemplary embodiment;

FIG. 2 is an example of connections of the ANT switching circuit and peripheral circuits according to the first exemplary embodiment of the present invention;

FIG. 3 is a graph illustrating a potential of an antenna connection terminal according to the first exemplary embodiment of the present invention;

FIG. 4 is an example of an ANT switching circuit according to a second exemplary embodiment;

FIG. 5 is an example of connections of the ANT switching circuit and peripheral circuits according to the second exemplary embodiment of the present invention;

FIG. 6 is a graph illustrating a potential of an antenna connection terminal according to the second exemplary embodiment of the present invention;

FIG. 7 is an example of an ANT switching circuit according to other exemplary embodiment;

FIG. 8 is an example of an ANT switching circuit according to a related art; and

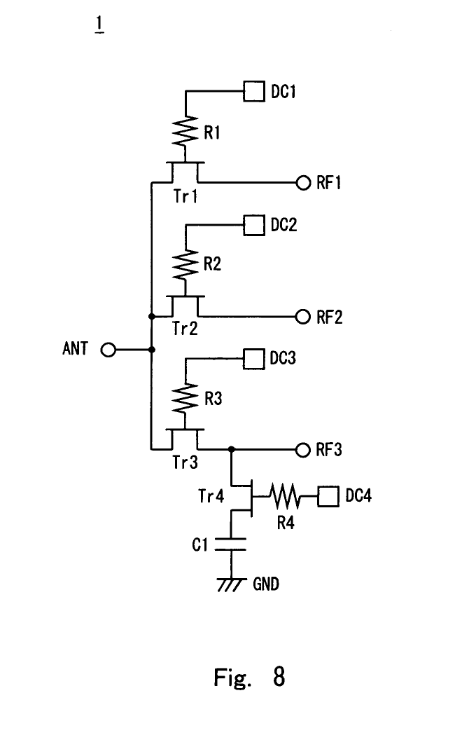

FIG. 9 is an example of an ANT switching circuit according to a related art.

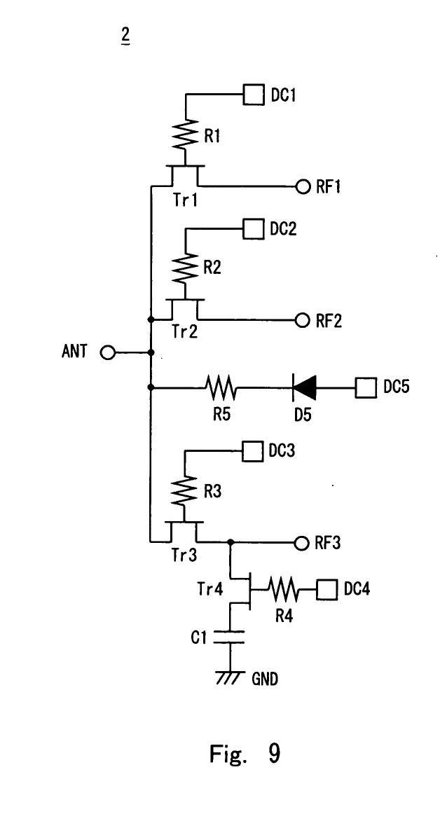

### DETAILED DESCRIPTION OF THE EXEMPLARY EMBODIMENTS

### First Exemplary Embodiment

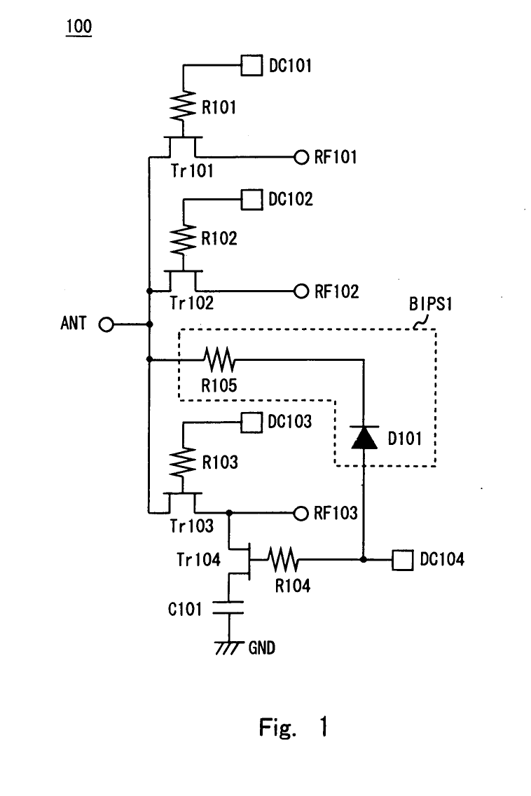

Hereinafter, a specific first exemplary embodiment incorporating the present invention is described in detail with reference to the drawings. The first exemplary embodiment applies the present invention to a switching circuit for switching antenna transmission and reception (the switching circuit hereinafter referred to as an ANT switching circuit). An example of the configuration of an ANT switching circuit 100 according to the first exemplary embodiment is illustrated in FIG. 1. The ANT switching circuit 100 has SPnT (Single pole, n throw) configuration (n=3). As illustrated in FIG. 1, the ANT switching circuit 100 includes an antenna connection terminal ANT, FETTr101 to Tr104, resistance elements R101 to R105, RF terminals RF101 to RF103, DC control voltage input terminals DC101 to DC104, and a diode D101.

One of a source and a drain of the FETTr101 is connected to the antenna connection terminal ANT, the other source or the drain is connected to the RF terminal RF101, and a gate is connected to one terminal of the resistance element R101. One of a source and a drain of the FETTr102 is connected to the antenna connection terminal ANT, the other source or the drain is connected to the RF terminal RF102, and a gate is connected to one terminal of the resistance element R102. One of a source and a drain of the FETTr103 is connected to the antenna connection terminal ANT, the other source or the drain is connected to the RF terminal RF101, and a gate is connected to one terminal of the resistance element R103. A drain of the FETTr104 is connected to the RF terminal RF103, a source is connected to one terminal of the capacitor C101, and a gate is connected to one terminal of the resistance element R104.

One terminal of the resistance element 101 is connected to the gate of the FETTr101, and the other terminal is connected to the DC control voltage input terminal DC101. One terminal of the resistance element 102 is connected to the gate of the FETTr102, and the other terminal is connected to the DC control voltage input terminal DC102. One terminal of the resistance element R103 is connected to the gate of the FETTr103, and the other terminal is connected to the DC control voltage input terminal DC103. One terminal of the resistance element R104 is connected to the gate of the FETTr104, and the other terminal is connected to the DC control voltage input terminal DC104. One terminal of the resistance element R105 is connected to the antenna connection terminal ANT, and the other terminal is connected to a cathode of the diode D101. Suppose that the resistance of the resistance elements R101 to R104 is Ra, the resistance of the resistance element R105 is Rb, and the relationship between them is Ra>Rb. Further, these resistance elements R101 to R104 are responsible for attenuating a high frequency signal spread through the gate capacitance of FET.

One terminal of the capacitor C101 is connected to the source of FETTr104, and the other terminal is connected to the ground voltage terminal GND. An anode of the diode D101 is connected to the DC control voltage input terminal DC104 and a cathode is connected to the other terminal of the resistance element R105. The path from the DC control voltage input terminal DC104 to the antenna connection terminal ANT through the resistance element R105 and the diode D101 is hereinafter referred to as a bias voltage supply path BIPS1.

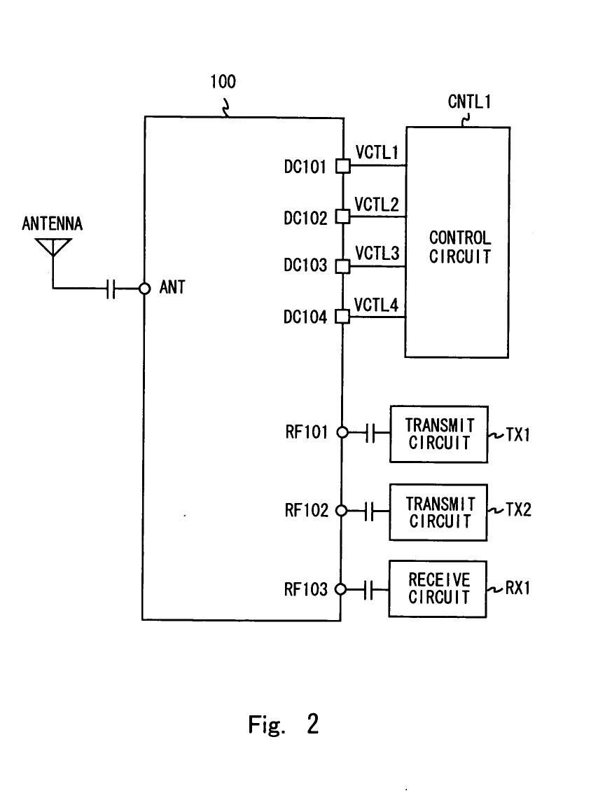

Such ANT switching circuit 100 is integrated into one chip and arranged in a semiconductor package. FIG. 2 illustrates a block diagram of the integrated ANT switching circuit 100 and peripheral circuits connected to the ANT switching circuit 100. As illustrated in FIG. 2, an antenna is connected to the antenna connection terminal ANT of the ANT switching circuit 100. Note that the capacitor connected between the antenna and the antenna connection terminal ANT has a function to cut off a DC component of a high frequency signal received from the antenna or transmitted to the antenna.

A transmit circuit TX1 is connected to the RF terminal RF101. The transmit circuit TX1 generates a high frequency signal including transmit data, and outputs it to the ANT switching circuit 100. Note that the capacitor connected between the transmit circuit TX1 and the RF terminal RF101 has a function to cut off a DC component of a high frequency signal. A transmit circuit TX2 is connected to the RF terminal RF102. The transmit circuit TX2 generates a high frequency signal including transmit data, and outputs it to the ANT switching circuit 100. Note that the capacitor connected between the transmit circuit TX2 and the RF terminal RF102 has a function to cut off a DC component of a high frequency signal.

A receive circuit RX1 is connected to the RF terminal RF103. The receive circuit RX2 generates a high frequency signal including receive data, and outputs it to the ANT switching circuit 100. Note that the capacitor connected between the receive circuit RX1 and the RF terminal RF103 has a function to cut off a DC component of a high frequency signal.

The DC control voltage input terminals DC101 to DC104 are connected to the control circuit CNTL1. Control voltages VCTL1 to VCTL4 output from the control circuit CNTL1 are applied respectively to the DC control voltage input terminals DC101 to DC104. When a transmit high frequency signal is output from the transmit circuit TX1 to the antenna, the control circuit CNTL1 sets the control voltage VCTL1 to high-level, and the control voltages VCTL2 and VCTL3 to low-level. Therefore, only the FETTr101 is turned on and the antenna connection terminal ANT and the RF terminal RF101 are electrically connected. The path of the antenna connection terminal ANT and the RF terminal RF101 is hereinafter referred to as a transmit path TXPS1.

When a transmit high frequency signal is output from the transmit circuit TX2 to the antenna, the control circuit CNTL1 sets the control voltage VCTL2 to high-level, and the control voltages VCTL1 and VCTL3 to low-level. Therefore, only the FETTr102 is turned on and the antenna connection terminal ANT and the RF terminal RF102 are electrically connected. The path of the antenna connection terminal ANT and the RF terminal RF102 is hereinafter referred to as a transmit path TXPS2. When the receive circuit RX1 receives the transmit high frequency signal received by the antenna, the control circuit CNTL1 sets the control voltage VCTL3 to high-level, and the control voltages VCTL2 and VCTL3 to low-level. At the same time, the control circuit CNTL1 sets the control voltage VCTL4 to low-level. Therefore, only the FETTr103 is turned on and the antenna connection terminal ANT and the RF terminal RF103 are electrically connected. The path of the antenna connection terminal ANT and the RF terminal RF103 is hereinafter referred to as a receive path RXPS1. Note that when the control voltage VCTL3 is low-level, the control circuit CNTL1 sets the control voltage VCTL4 to high-level. Moreover, although the receive circuit RX1 is connected to the RF terminal RF103 in this example, a transmit circuit may be connected to the RF terminal RF103 instead of the receive circuit.

An operation of the ANT switching circuit 100 of the above configurations is explained hereinafter. First, if one of the transmit path TXPS1 and TXPS2 is conducted, a high power high frequency signal is transmitted from the transmit circuit TX1 or TX2 to the antenna connection terminal ANT. In this case, either the control voltage VCTL1 or VCTL2 becomes high-level, and either the transmit path TXPS1 or TXPS2 is conducted. The receive path RXPS1 must be isolated to prevent the high frequency signal for transmission from leaking into the receive circuit RX1. Thus, the FETTr104 is turned on and the receive path RXPS1 is grounded in high frequency.

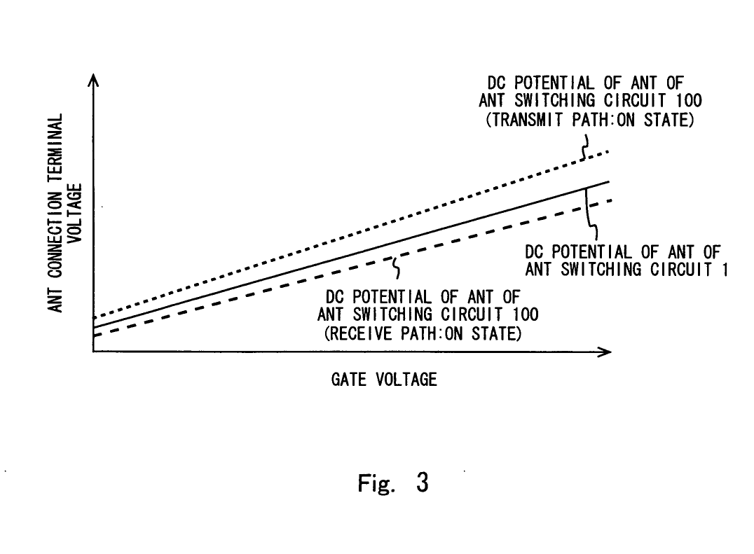

Therefore, if one of the transmit path TXPS1 and TXPS2 is turned on, the control circuit CNTL1 sets the control voltage VCTL4 to high-level. The antenna connection terminal ANT is connected to the DC control voltage input terminal DC104 by the bias voltage supply path. If the control voltage VCTL4 becomes high-level and a potential difference between anode and cathode of the diode D101 exceeds a predetermined value, the diode D101 is turned on. Therefore, the antenna connection terminal ANT and the DC control voltage input terminal DC104 are electrically connected, and the potential of the antenna connection terminal ANT increases. FIG. 3 is a graph illustrating the potential of the antenna connection terminal ANT in the case when the transmit path XPS1 or TXPS2 is turned on and the case when the receive path RXPS1 is turned on. FIG. 3 also illustrates the potential of the antenna connection terminal of the ANT switching circuit 1. As illustrated in FIG. 3, the antenna connection terminal ANT can ensure a high potential if the transmit path is turned on. This solves the problem of the ANT switching circuit 1 according to a related art that FET cannot maintain the OFF state if a high power high frequency signal is input.

On the other hand, if the receive path RXPS1 is conducted, the FETTr104 is turned off because a receive high frequency signal from the antenna is transmitted to the receive circuit RX1 and the receive path RXPS1 is shorted out in high frequency. Therefore, the control circuit CNTL1 sets the control voltage VCTL4 to low-level. In this case, the control voltage VCTL4 becomes low-level voltage, and the diode D101 is turned off. Accordingly, the voltage is not supplied via the bias voltage supply path BIPS1, and the potential of the antenna connection terminal ANT is reduced as illustrated in FIG. 3. The case when the receive path RXPS1 is in a conducting state indicates the case in which the antenna receives a weak high frequency signal from an external device. Therefore, only a low power high frequency signal which is a receive signal is input to the antenna connection terminal ANT. This will not generate the problem that FET cannot maintain the OFF state if a high power high frequency signal is input

As described above, the ANT switching circuit 100 of the first exemplary embodiment includes a shunt FET (FETTr104 of the first exemplary embodiment) connected between the receive path RXPS1 and the ground voltage terminal GND. The FETTr104 has a function to improve the isolation of the receive path RXPS1 for a transmit signal. The ANT switching circuit 100 includes the bias voltage supply path BIPS1 between the antenna connection terminal ANT and the DC control voltage input terminal DC104 in order to supply a bias voltage to the antenna connection terminal ANT.

Generally, in the switching circuit for transmitting a transmit/receive signal of a communication device, a transmit path is required for high output characteristics in order to transmit a high power transmit high frequency signal amplified by a power amplifier or the like, but a receive path is not required for high output characteristics as the receive path transmits a weak power receive high frequency signal. Accordingly, the above ANT switching circuit 100 uses the control voltage VCTL4 of the DC control voltage input terminal DC104 for turning on or off the FETTr104, and supplies the bias voltage to the antenna connection terminal ANT. The ANT switching circuit 2 does not require an additional DC supply terminal for a bias voltage and achieves an opposite direction gate bias to FET in the OFF state only in the case that high output characteristics are required.

### Second Exemplary Embodiment

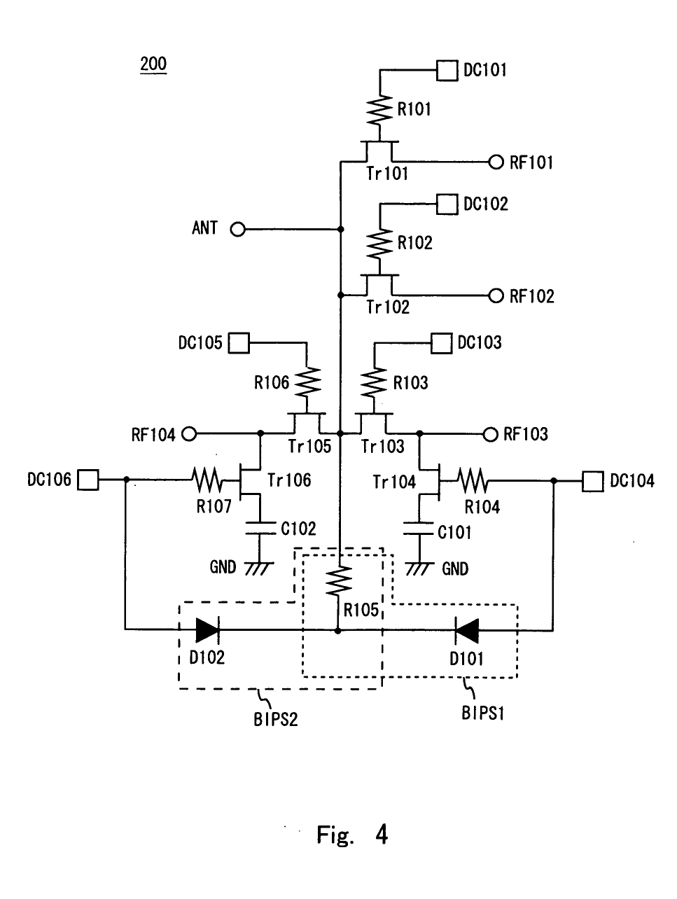

Hereinafter, a specific second exemplary embodiment incorporating the present invention is described in detail with reference to the drawings. The second exemplary embodiment applies the present invention to a switching circuit for switching antenna transmission and reception in a similar way as the first exemplary embodiment. An example of the configuration of an ANT switching circuit 200 according to the second exemplary embodiment is illustrated in FIG. 4. The ANT switching circuit 200 has SPnT (Single pole, n throw) configuration (n=4). As illustrated in FIG. 4, the ANT switching circuit 200 includes an antenna connection terminal ANT, FETTr101 to Tr106, resistance elements R101 to R107, RF terminals RF101 to RF104, DC control voltage input terminals DC101 to DC106, and diodes D101 and D102. In FIG. 4, components denoted by reference numerals identical to those in FIG. 1 indicate the identical or similar configuration as FIG. 1. The difference from the first exemplary embodiment is that there are multiple receive paths as with the transmit paths. The difference of the second exemplary embodiment from the first exemplary embodiment is mainly discussed.

One of a source and a drain of the FETTr105 is connected to the antenna connection terminal ANT, the other source or the drain is connected to the RF terminals RF104, and a gate is connected to one terminal of the resistance element R106. One of a source and a drain of the FETTr107 is connected to the RF terminal RF106, the other source or the drain is connected to one terminal of the capacitor C102, and a gate is connected to one terminal of the resistance element R107.

One terminal of the resistance element R106 is connected to the gate of the FETTr105, the other terminal is connected to the DC control voltage input terminal DC105. One terminal of the resistance element R107 is connected to the gate of the FETTr106, the other terminal is connected to the DC control voltage input terminal DC106. Suppose that the resistance of the resistance elements R101 to R104, R106, and R107 is Ra, the resistance of the resistance element R105 is Rb, and the relationship between them is Ra>Rb.

One terminal of the capacitor C102 is connected to either a source or a drain of the FETTr106, and the other terminal is connected to the ground voltage terminal GND. An anode of the diode D102 is connected to the DC control voltage input terminal DC106 and a cathode is connected to the other terminal of the resistance element R105. The path from the DC control voltage input terminal DC104 to the antenna connection terminal ANT through the resistance element R105 and the diode D101 is hereinafter referred to as a bias voltage supply path BIPS1. Further, the path from the DC control voltage input terminal DC106 to the antenna connection terminal ANT through the resistance element R105 and the diode D102 is hereinafter referred to as a bias voltage supply path BIPS2.

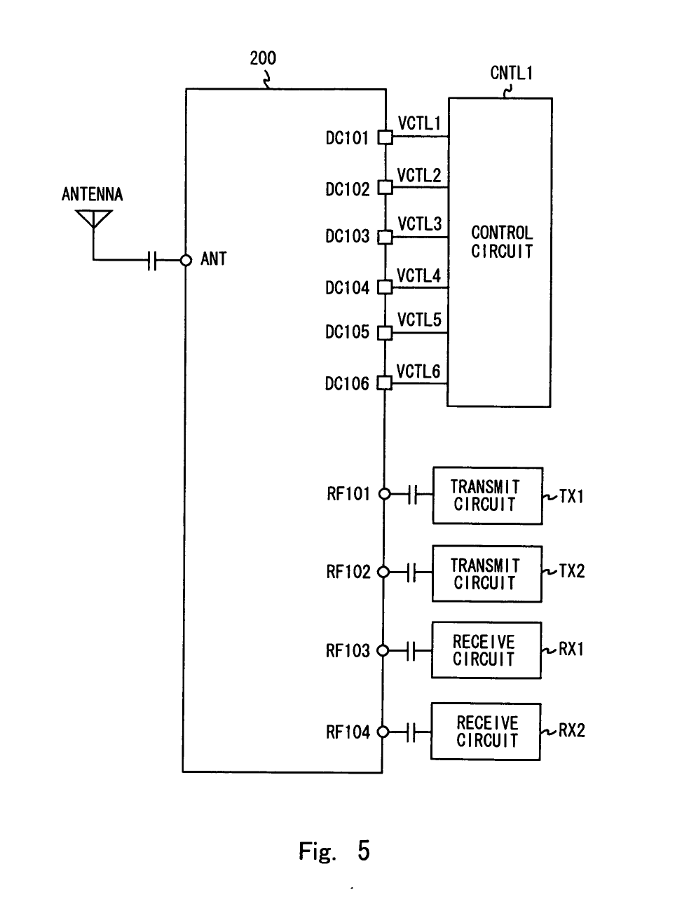

As illustrated in FIG. 5, the RF terminal RF106 is connected to the receive circuit RX2. Further, the DC control voltage input terminals DC105 and DC106 are connected to the control circuit CNTL1, and are supplied with the control voltage VCTL5 and VCTL6, respectively. When the receive circuit RX2 receives the transmit high frequency signal received by the antenna, the control circuit CNTL1 sets the control voltage VCTL5 to high-level, and the control voltages VCTL1 to VCTL3, and VCTL5 to low-level. Therefore, the FETTr105 and the Tr104 are turned on. Thus, the antenna connection terminal ANT and the RF terminal RF104 are electrically connected. The path is hereinafter referred to as a receive path RXPS2. Note that when the control voltage VCTL5 is low-level, the control circuit CNTL1 sets the control voltage VCTL6 to high-level. Other configuration is the same as the ANT switching circuit 100.

An operation of the ANT switching circuit 200 of the above configurations is explained hereinafter. First, if one of the transmit path TXPS1 or TXPS2 is conducted, that is, if a high power high frequency signal is transmitted from the transmit circuit TX1 or TX2 to the antenna connection terminal ANT, the FETTr104 and Tr106 are turned on and the receive paths RXPS1 and RXPS2 are grounded in high frequency to achieve isolations of the receive paths RXPS1 and RXPS2, as with the first exemplary embodiment.

Therefore, if the transmit path TXPS1 or TXPS2 is conducted, the control circuit CNTL1 sets the control voltages VCTL4 and VCTL6 to high-level. The antenna connection terminal ANT is connected to the DC control voltage input terminals DC104 and DC106 respectively by the bias voltage supply paths BIPS1 and BIPS2. If the control voltage VCTL4 and VCTL6 become high-level and the potential difference between anode and cathode of the diodes D101 and D102 exceeds a predetermined value, the diodes D101 and 102 are turned on. Therefore, the antenna connection terminal ANT and the DC control voltage input terminals DC104 and DC106 are electrically connected, and the potential of antenna connection terminal ANT increases. Accordingly, this solves the problem that FET cannot maintain the OFF state if a high power high frequency signal is input to the ANT switching circuit 1.

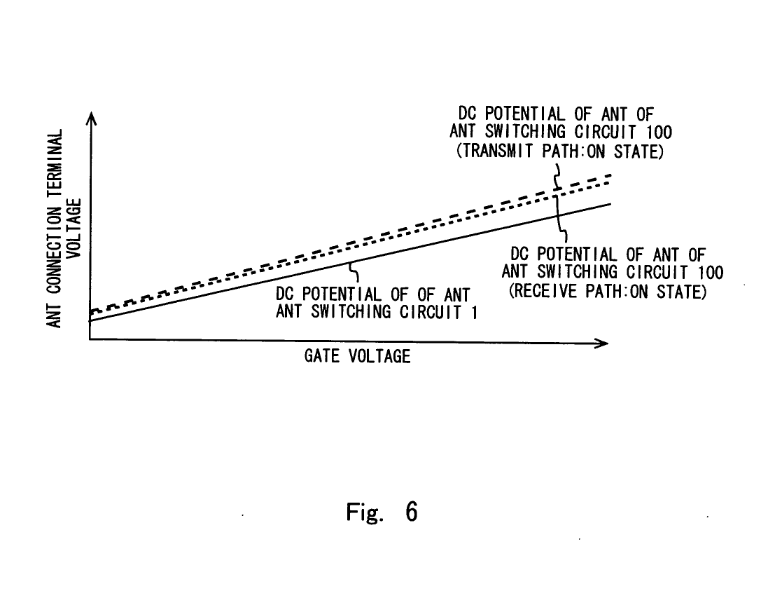

On the other hand, if the receive path RXPS1 or RXPS2 is in a conducting state, the FETTr104 or Tr106 is turned off because a receive high frequency signal from the antenna is transmitted to the receive path RXPS1 or RXPS2 and the receive path RXPS1 or RXPS2 is grounded in high frequency. Therefore, the control circuit CNTL1 sets the control voltage VCTL4 or VCTL6 to low-level. In this case, the control voltage VCTL4 or VCTL6 becomes low-level, thus the diode D101 or D102 is turned off. However, unlike the first exemplary embodiment, either the bias voltage supply path BIPS1 or BIPS2 supply a potential to the antenna connection terminal ANT. Therefore, the potential of the antenna connection terminal ANT is hardly reduced. FIG. 6 is a graph illustrating the potential of the antenna connection terminal ANT in the case when the transmit path is in the ON state and the case when the receive path is in the ON state. FIG. 6 also illustrates the potential of the antenna connection terminal ANT of the ANT switching circuit 1 according to a related art. As can be seen from FIG. 6, the antenna connection terminal ANT can achieve a high potential in both cases if the transmit path is in the ON state and the receive path is in a conducting state. Therefore, in the ANT switching circuit 1, even if a high power high frequency signal is input from the transmit circuit and if the ANT switching circuit 200 inputs a high power high frequency signal, the problem that FET cannot maintain the OFF state can be solved.

Note that the present invention is not limited to the above exemplary embodiments but may be modified as appropriate within the scope of the present invention. For example, in the first and the second exemplary embodiments, the switching circuit is SpnT type with a single antenna (where n is an integer of 2 or more), however the switching circuit may be mPnT type (where m and n are integers of 2 or more) with multiple antennas. Note that in this case, the bias voltage is applied to the common node to which multiple switching transistors (corresponding to the FETTr101 to Tr103 of the first exemplary embodiment) are connected.

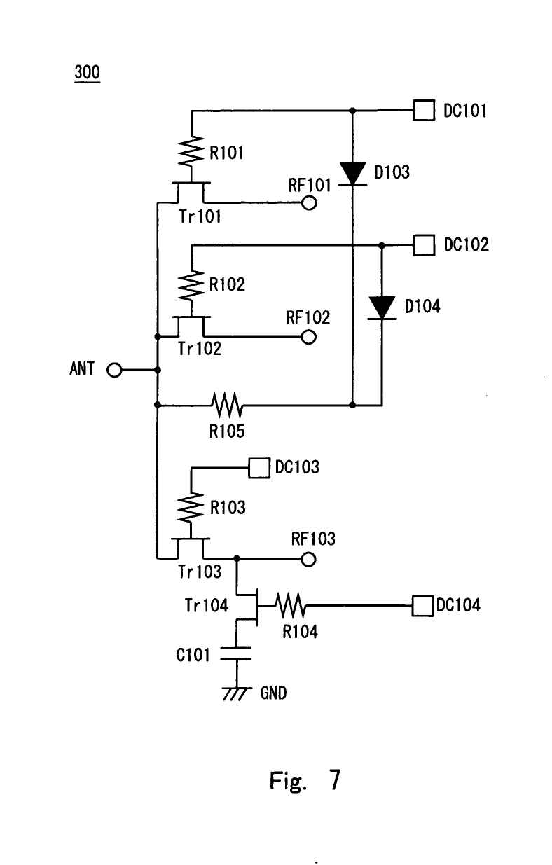

Further, a bias voltage may be supplied to the antenna connection terminal ANT when the transmit path is in a conducting state, that is, when a high power high frequency signal is input. Accordingly, it may be the configuration as in a ANT switching circuit 300 illustrated in FIG. 7, in which if the transmit path TXPS1 or TXPS2 is in a conducting state, a high level potential supplied to the DC control voltage input terminal DC101 or DC102 is transmitted to the antenna connection terminal ANT.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A switching circuit comprising:
a first transfer path and a second transfer path that transfer a high frequency signal;
a first transistor that electrically cuts off a common node between the first transfer path and the second transfer path and the first transfer path if the high frequency signal is transferred via the second transfer path;
a second transistor that electrically cuts off the common node and the second transfer path if the high frequency signal is transferred via the first transfer path;
a first control voltage input terminal that inputs a high-level control voltage if the high frequency signal is transferred via one of the first transfer path and the second transfer path; and
a first voltage supply path that supplies a voltage according to the high-level control voltage to the common node.

2. The switching circuit according to claim 1, wherein
the first voltage supply path includes a diode, and
an anode of the diode is connected to the first control voltage input terminal and a cathode of the diode is connected to the common node.

3. The switching circuit according to claim 1, further comprising:
a third transfer path that is connected to the common node and transfers a high frequency signal, the high frequency signal having lower power than the high frequency signal transferred via one of the first transfer path and the second transfer path;
a third transistor that electrically cuts off the common node and the third transfer path if the high frequency signal is transferred via one of the first transfer path and the second transfer path; and
a fourth transistor, wherein
a control terminal of the fourth transistor is connected to the first control voltage input terminal and electrically connects the third transfer path and a ground terminal if the high-level control voltage is input.

4. The switching circuit according to claim 3, further comprising:
a first resistance element that is connected between the control terminal of the fourth transistor and the first control voltage input terminal; and
a second resistance element that is connected between the cathode of the diode and the common node,
wherein a resistance of the second resistance element is smaller than a resistance of the first resistance element.

5. The switching circuit according to claim 1, wherein
an antenna is connected to the common node, and
one terminal of the first transistor and the second transistor is connected to the common node, and another terminal of the first transistor and the second transistor is connected to a transmit circuit that outputs the high frequency signal for transmission, and
one terminal of the third transistor is connected to the common node and another terminal is connected to a receive circuit that inputs the high frequency signal for reception.
